(19) United States
(12) Patent Application Publication
(10) Pub. No.: US 2016/0247205 A1
(43) Pub. Date: Aug. 25, 2016

(54) System and Method to Serve One or More Advertisements with Different Media Formats to One or More Devices

(71) Applicant: YUUZOO CORPORATION, Singapore (SG)

(72) Inventors: THOMAS HENRIK ZILIACUS, SINGAPORE (SG); ASIM IQBAL QURESHI, SINGAPORE (SG)

(21) Appl. No.: 15/026,398

(22) PCT Filed: Oct. 3, 2014
(86) PCT No.: PCT/SG14/00466

§ 371 Date: Mar. 31, 2016

(30) Foreign Application Priority Data
Oct. 4, 2013 (SG) 201307747-4

(51) Int. Cl. G06Q 30/02; G06Q 50/00; H04L 29/08

(52) U.S. Cl. CPC G06Q 30/0269; H04L 67/22; G06Q 30/0201; G06Q 30/0255; G06Q 30/0267; G06Q 50/01

(57) ABSTRACT

A number of embodiments are described of social e-commerce networking systems and methods. A social e-commerce networking system, having one or more users, where one user with a device, or multiple devices, that logs into a social e-commerce networking system, allows one or more advertisers to serve one or more advertisements, with different messages or different media formats, to one or more mobile or computing devices of a logged user to the social e-commerce networking system, at different points of time, and at different locations. One embodiment is a social e-commerce media networking platform system that is based on a ‘network of social networks’, in which the platform system encompasses multiple targeted social networks, including those of specific interests. These networks may also be targeted emphasizing specific user groups based on their interests, age or location. These networks may then be connected to each other, with allowance of one or more users to register one or more of these networks to be allowed to freely explore, through and with use of the social e-commerce media networking platform system, the contents of these one or more networks and allow a user to interact with one or more users across all networks or one or more networks that a user may choose, and without any additional sign-ups to each of these networks needed by a user.

### FIELD OF INVENTION

This invention relates generally to social e-commerce networking systems and methods, and in particular to allow advertisers to serve one or more advertisements to one or more devices, whether mobile or computing.

### BACKGROUND OF THE INVENTION

Social networking is now a big part of how many people communicate and keep in touch. For many young consumers, these networks are becoming more the center of commerce, given that many do their shopping online. A trend among these consumers is a growing distrust of traditional advertising methods, with more interest in tips from others in their social networks. Some solutions to address these concerns are to present tools so their customers can like or follow. Results of such actions are that businesses lose customer control, and revenue. Customers are pushed by the business or brands to environments where the social network, not the brand, is able to monetize the consumer through paid advertising and sale of services and merchandise.

To stay in touch with existing social network environments, or those developing almost on a daily basis, is no longer enough. For businesses it is more a task to manage connections of these networks. Social networks that offer targeted networks likely keep consumers in these focused networks as opposed to general networks. This means possibly more advertising revenue for the advertiser or the brand.

SUMMARY OF INVENTION

To address the above social networking concerns, social e-commerce networking systems and methods are provided to allow advertisers to serve one or more advertisements to one or more mobile or computing devices of the logged user that are in use. A preferred embodiment comprises a system of a plurality of user devices connected to one or more servers, there is a group identification that associates a logged user into the social e-commerce networking system with a targeted interest group which is chosen by the logged user, a data mining engine that is incorporated with at least one of the servers and at least one of the targeted interest groups, configured to (1) collect about each logged user continuous real time contextual data, (2) to filter by each of the targeted interest groups selected by the logged user the collected continuous real time contextual data into different groups, identified by a different group identification, and (3) to push out the data based on any request of that data. An advertising engine is also connected to the one or more servers, as well as the data mining engine, is configured to share data with the data mining engine, or to request data from the data mining engine. The advertising engine then prepares to serve the one or more advertisements that are provided by the one or more advertisers, with the serving of the advertisements to be in media formats based on device type.

The advertising engine performs the serving of the one or more advertisements, which is conditioned upon receiving from an advertiser a request that includes one or more data parameters. The data parameters are based on criteria, including data related to the user, their profile, the targeted interest group chosen by the user, whether these one or more devices in use by the user are mobile or computing devices, the continuous real-time contextual information collected about the user, the contextual information related to location, and the contextual information related to time. The advertising engine then retrieves the requested data from the data mining engine. With a match between the advertiser's request and data parameters and the collected contextual data, the advertising engine directs the servers to serve one or more advertisements to the corresponding devices of the logged user, again the per device type, context to location, context to time, and in media formats based on device type. The preferred embodiment allows an advertiser to serve one or more advertisements, with different messages or different media formats, or different messages and different media formats, to one or more devices of logged users within different filtered targeted interest groups based on group identification of a user. These advertisements are then served per context to location and to time or per location or to time.

The media format of the advertisement may be conditioned on the type of device in use by the user. For example, if the user is using a mobile device, the advertisement may be served in text format. If the user is logged into the system with a laptop device, the one or more advertisement's media format served may comprise text, images, video, or high-definition versions of the same. The number of advertisements that may be presented by the advertiser may be limited by the number of devices in use by the user. Besides determining the media format of the advertisements that may be served to the devices in use by the user, the advertising engine, based on the parameters in the requests from the advertisers and the data shared from the data mining engine, determines whether to serve the same, different, or a combination of the same and different advertisements to the devices in use by the user. Where the data shared between the advertising engine and the data mining engine does not satisfy the parameters in the requests from the advertisers, the advertising engine may actively instruct the data mining engine to collect the requested data.

A social e-commerce media networking platform, or social e-commerce networking system, includes targeted social networks that may be filtered by any age, interest, or location. Additionally, it may be based on a ‘network of social networks’, in which the platform system encompasses multiple targeted social networks, including those of specific interests. Examples of linked networks specific to interest includes teens, babies, games, trade, coffee, harmony, mums, gossip, and many more. The linked networks comprise a changing list of groups that is continuously updated or revised. These networks may then be connected to each other. After logging into the social e-commerce media networking platform system, each of the one or more users, via registration to each of the one or more networks, and without needing to perform an additional sign-up with each of these networks. Each of the one or more users can then explore the advanced, flexible, dynamically changed or updated contents of these one or more networks. Each of the one or more users may then interact, or search across all networks, including the one or more networks that a user has chosen.

In another implementation, a social e-commerce media networking platform, or social e-commerce networking system, may include these networks, and in addition to supporting one or more interest or location centric interaction amongst one or more users, the platform or system of these networks may also offer integrated e-commerce shops, advertising platforms and mobile payment services. The system or platform may acts as a “master social network”, wherein one or more users may explore or consume all available content within one or more inter-linked networks, including but not limited to specific target groups of one or more interests, and such allow interaction with the one or more users. The one or more users have the allowance to make online purchases, relevant to the content of the network, or one or more networks, from which the one or more users shops, without compromising a highly targeted, localized and user-friendly experience. One embodiment of this implementation may comprise of networks, which include those targeted on specific interests, developed to satisfy many purposes, including one directly for consumers.

Additionally a branded network may be developed in consideration of a number of potential users, including corporate clients or brands. The one embodiment may comprise network subscriptions or branded network developments, where included functionality or services for each of these networks may include marketing by the platform, selling by the platform, system, franchises, resellers, or other partners.

An alternative implementation comprises an enablement in consideration of one or more consumers, or users, of the system, or platform, to any of the other one or more social networks, or targeted interest networks, within a branded network. What may be allowed is an enablement of a link to any of the one or more social networks from within the one or more targeted networks, which has been created to be included into the one or more systems, or platforms, that have been built for a brand. The implementation may include functionality to allow a post on a brand's targeted network to be posted on any of the other one or more social networks, or targeted interest networks, and vice versa. In other words, a post on any social network may then be posted on a brand's targeted network. This allows other one or more social networks, or targeted interest networks, to be linked into the brand's targeted network, where then the brand can attain advantages, including driving of membership. A brand may monetize one or more consumers, or users, within the brand's network.

Included functionality has a brand, through its one or more networks, no longer needing to push one or more consumers, or users, to any of the other one or more social networks, or targeted interest networks, from which these consumers or users are to “like” or “follow” the brand. The consumers, or users, may stay in the network of the brand, whereby a brand may monetize these consumers or users, by use of a variety of means, including advertisements, e-commerce or payment services.

An alternative implementation comprises a social e-commerce media networking platform, or social e-commerce networking system, which may enable a brand to collate one or more mentions, or one or activities, in other social networks in one single platform for a brand incorporated within the system or platform. The system or platform offer a brand various functionality, with offering s including insight and return on investment (ROI) to measure any campaign or activity implemented by a brand within the system or platform.

This Summary herein is not intended to be used to limit the scope of, or identify essential features of, the claimed subject matter. The summary does attempt to simplify the inventive key which in the description following will be discussed further.

BRIEF SUMMARY OF THE DRAWINGS

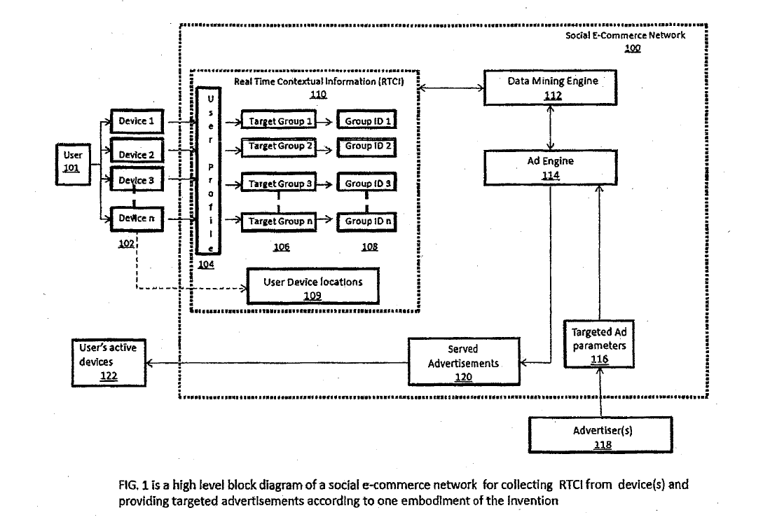

FIG. 1 is a high level block diagram of a social e-commerce network to collect RTCI from one or more devices and providing targeted advertisements according to one embodiment of the invention.

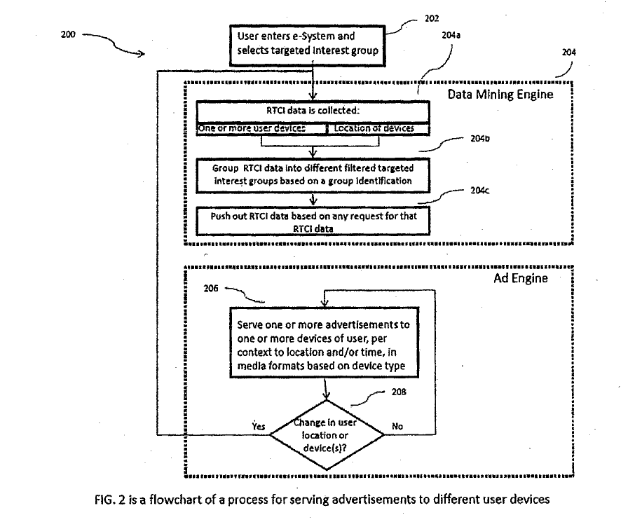

FIG. 2 is a flowchart of a process to serve advertisements to different user devices according to one embodiment of the invention.

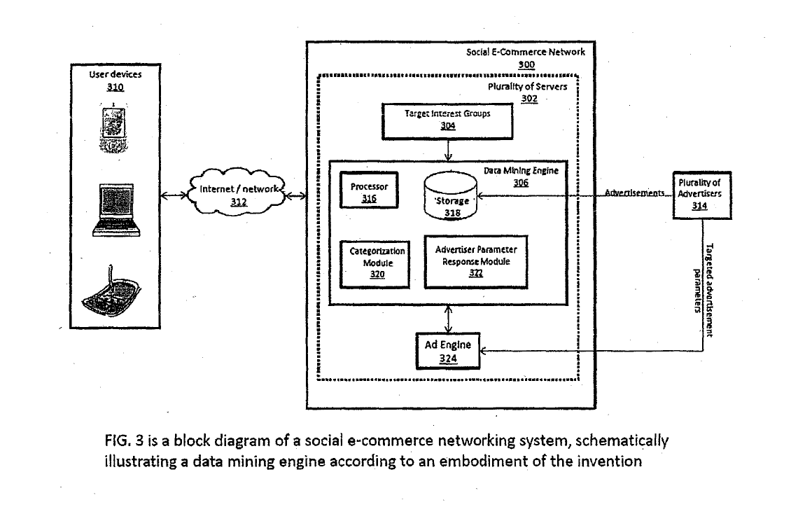

FIG. 3 is a block diagram of a social e-commerce networking system, schematically illustrating a data mining engine according to an embodiment of the invention.

Note one skilled in the art can recognize from the discussion herein alternative embodiments for the inventive systems and methods, and such may be construed without deviating from the invention's principles noted herein. The figures included herein present embodiments for illustration only. The figures herein may present separate functional blocks; however, these blocks may not be separate with respect to physicality or functionality. For ease of presentation, the figures herein may show alternate computing tasks through use of hardware objects, including memory and data storage. Software, capable to run on one or more processors, or compatible logic devices, may be provided or utilized, and which may be provided internally in a system or different media available to hold and transfer the software, including flash drives or any non-volatile memory devices.

### DETAILED DESCRIPTION OF THE INVENTION

FIG. 1 illustrates a high level block diagram of one embodiment of a social e-commerce networking system (e-System) 100. The preferred embodiment comprises an e-System 100 where there are one or more users that may log into the e-System 100. One implementation is to describe a user 101, with the description of the user 101 to be one typical example of how each and every user may enter the e-System 100, and what the system does related to data gathered about a user 101. There may be a plurality of users that choose to login to the e-System 100, and such choose to interact with both the e-System 100 as well as with other users via a plurality of social media target groups 106 focused on specific interests.

A user 101 may have one or more devices 102 available for use. The devices 102 of a user 101 are to include configuration or functionality to allow the device to communicate via any network, or internet. The choice of internet or available networks is to allow any computing or mobile types to perform receipt and transmittal of data, with adaptability to allow connection to any social network, and may comprise most any wired or wireless networks. An embodiment may include devices 102 using one of a variety of available operating systems, for example including an operating system compatible with iOS, ANDROID, Microsoft Windows, Apple OS, of Linux based operating systems. The types of devices 102 may include, but are not limited to, personal digital assistants, tablets, smart phones, laptop computing systems, net books, desktop computers, and other devices that integrate computing and data communication functionality All devices 102 may then utilize a variety of applications to allow interaction with a social networking system, including but not limited to the e-System 100. The applications which a device 102 of a user 101 may include a browser application or an application programming interface, which can function on or within one or more devices 102, with any of the available operating systems.

The user 101 may use one or all of these devices 102 at the same time, including for logging into the e-System 100 at different times and different locations.

Upon login for the first time to the e-System 100 with any of these devices, the user will prepare and complete their user profile 104. The user profile 104 includes information about the user 101, and may include data that describes the user 101 in more detail, such as demographics, biographical, including age, income, education, gender, preferences, location, type of device 102, preferred images or videos, etc.

The user profile 104 is dynamic, and changes or expands based on data provided by a user 101. Included in the data found in the user profile 104 are the one or more devices 102 associated with a user 101. A profile of a user 101 is built in the e-System 100 that includes the devices a user 101 may use to access the e-System, such that future interaction, specifically related to login, may be allowed given the devices 102 associated with a user. Subsequently, the e-System 100 may then be accessible by login to a user 101 via any of the devices 102 which are assigned to that user. This data collection of the devices 102 enables the e-System 100 to allow a user 101 access via their one or more devices 102, including interaction within various target interest groups 106. The e-system is providing functionality to exploit the expanding use of different multiple devices by one user, wherein an advertiser, or brand, may be provided one view of a user 101, or potential consumer, across the one or more devices 102 attached to the user 101, in order to push specific messages, requests, or offers to such users 101 on these devices 102, based on context related to time or location. The e-system 101 utilizesfunctionality to allow users 101 to be able to login to the e-System 100 via each of the devices 102 indicated by a user 101 as active in relation to the e-System 100. Subsequently, advertisers may approach each user 101, or users, of the e-System 100 specifically to the target interest groups 106 available and insight gathered from data for users 101 to access and engage based on the one or more devices 102 of a user 101.

A user 101 upon subsequent login to the e-System 100 may update their user profile 104 during any active session while logged in the e-System 100. Upon login for the first time, or subsequent logins, to the e-System 100, a user 101 selects among a network of social networks, including specificity to target interest groups 106, in which a user 101 possibly may be interested. The user 101 may select and join from among a network of social networks in which the e-System 100 has made available, including multiple targeted social networks of different interests. Each active device 102 may indicate to the e-System 100 what type of device it is, and where it is located, including technical specifications, such as its screen size or browser size capacities. If the device 102 is a laptop, for example, then the e-System 100 knows this information. If the device 102 is a mobile device, then it is recognizable as a mobile device and mobile advertisements may be served.

For each selection of a target interest group 106 by a user 101, the e-System 100 assigns to that user 101 a group identification 108. A group identification 108 may be assigned for a number of reasons, including a user 101 selecting a target interest group 106, getting involved in a conversation with one other use, getting involved with a group of users, or other selections or interactions while logged into the e-System 100. One user 101 may select one or more target interest groups 106, and subsequently may be given one or more group identifications 108. All this data related to a user 101 while logged into the e-System 100 is collected and stored by the e-System 100 through use of its data mining engine 112. The data process for collected, storage, and other related functions are performed for the one or more users 101 that may login to the e-System 100. Data is collected one group identification 108 at a time, and with collection only including the group identification 108 that is active. The data related to a user 101 is collected from among the plurality of target interest groups 106 available in the e-System 100 one group at a time, and then collectively stored and sorted according to each user 101. Collection is made from the first time a user enters the e-System 100, and builds on data provided by a user 101 during all time in the e-System 100. Where a user 101 changes their target interest group 106, or logs into the e-System 100 with a different device 102, the data is collected. To attempt to build a better understanding of a user 101 and their activities in a social network, including an e-System 100, there is continuous collection of postings, conversations, and other contextual direct or indirect information. The possible result is to build an understanding of online social network activity, resulting in a dynamic, growing profile of a user 101.

Real time contextual information (RTCI) 110 may be collected from the one or more mobile or computing devices 102 of the logged user 101 that are in use. Each active device 102 may indicate to the e-System 100 what type of device it is, and where it is located, including technical specifications, such as its screen size or browser size capacities. If the device 102 is a laptop, for example, then the e-System 100 knows this information. If the device 102 is a mobile device, then it is recognizable as a mobile device and mobile advertisements may be served. The RTCI 110 data collected may be used to perform other functions and purposes besides only advertising, including commerce, payment, and other different contextual content.

An embodiment includes a user 101 that has logged into the e-System 100. The user 101 upon login based on a targeted interest group 106 of choice is given a group identification 108 by the e-System 100. A user 101 is provided group identification 108 associated with each targeted interest group 106 selected, and then joined within the e-System 100. So a user 102 may have multiple numbers of group identification 108 given association with one or more targeted interest groups 106 within the e-System 100. However, a user may be associated with only one group identification 108 at one time, while logged into the e-System 100, with allowance to change group identification 108 among the user's targeted interest groups 106 while logged into the e-System 100. Throughout a day a user 102 may select one or more mobile or computing devices 102 to connect with the e-System 100. The RTCI 110 is continuously collected data about a user 101 while logged into the e-System 100. The data is collected against certain parameters that are provided by either the advertiser, other clients, or by the company itself. The parameters used to collect this data may be constantly changed, updated, or edited by requests from the advertiser, other clients, or by the company itself. The preference of data collection may consider context first related to a device, then to consider a location, and then based on a time. Additional data included within what is collected by the RTCI 110 is location-based data 109 associated with each of the devices 102 of a user 101. The RTCI 110 includes continuous real-time collection of data related to context based on conversations of a user 101, locations of the devices 109, on a time when a user 101 is at a certain location 109, and regarding devices 102 a user 101 is currently using. This RTCI 110 is data collected about each user of the e-System 100. The more a user 101 is logged and active in the e-System 100, the more data can be gathered. The more a user 101 is logged in the e-System 100, and within one of the targeted interest groups 106, the more data about the user, including specifically regarding this one targeted interest group 106 can be gathered. Over periods of time the RTCI 110 data collected may establish a more precise representation of the user 101 in the user's profile with corresponding RTCI 110 data. The RTCI 110 may also collect continuous real-time data of a user 101 during their daily activities within the e-System 100 while they are logged in. A user profile 104 is further considered by the RTCI 110 to add context to the data gathered related to a user 101. One embodiment may comprise a user 101 in one day may journey from their home to the office by use of a train. At the office, in a large retail and commercial complex, a user 101 works and has lunch. At the close of the workday, a user 101 leaves the office, and by use of the train, returns to their home, which may include shopping at a nearby mall. During the journey of a user 101 throughout the day, a user 101 may use one or more of their devices 102 that offer wireless or wired network connectivity, including a number of laptop computing devices, mobile phones, tablets, office workstations, entertainment devices, etc. The RTCI 110 collects continuously from each user 101 that logs into the e-System 100 the data related to a user 101 and their devices 102, including the locations 109 of the devices 102 and any updates to the user profile 104. The RTCI 110 includes collection of the data about all users that have logged into the e-System 100, with the data collected for each of the users consistent in how it is collected, with data varying based on the interests associated with each of the users, and what each user does while logged into the e-System 100.

The data mining engine (DME) 112 is configured to collect the RTCI 110 data continuously about the users from social networking, a targeted interest group 106 based on group identification 108, from various mobile apps, including the company's own apps, and with data including the location 109 of the user 101, the user's one or more mobile or computing devices 102 when logged into the e-System 100 through these corresponding devices 102, as well as any updates to the user profile 104. Besides being configured to collect any continuous real time contextual information data as mentioned herein, the DME 112 further has functionality to group the collected RTCI 110 data, including into different filtered targeted interest groups 106 based on group identification 108. The DME 112 may then organize this collected data about each user 101 of the e-System 100. The DME 112 stores this data, and makes this data available for whoever is requesting the data. The DME 112 pushes any of this data that has been collected based on any request of this data, and according to parameters of the request made to the DME 112.

One embodiment related to this data collection and request from the DME 112 is where an e-commerce portal advertising client can request to be given users that have certain income levels and that these users need to be in certain countries. So these are the parameters that need to be passed to the DME 112 from this other different engines. Based on this request sent, the DME 112 just responds to the request by sharing the desired data. A DME 112 can be incorporated with the servers associated or connected together in the e-System 100. Further, a DME 112 is connected with the plurality of user devices 106 upon login by the user 102. The DME 112, with this collection of data about all the users that have logged into the system, then shares this data with the advertising engine (Ad engine) 114. The DME 112 is bilaterally connected with the Ad engine 114.

An Ad engine 114 may be connected with the servers associated or connected together in the e-System 100, as well as connected with the DME 112. While the

DME 112 collects all the RTO 110 data, the Ad engine 114 does not process the data. The Ad engine 114 identifies a user 102 based on the device 106 they are using, with the Ad engine 114 configured to share data bilaterally with the DME 112, or to request data from the DME 112. The Ad engine 114 then prepares to serve one or more advertisements 120 in different media formats based on device type. While the advertiser 118 may transfer their advertisements 120 in the form and media format they prefer, an advertiser 118 through their targeted advertisement parameters 116 can specify when these advertisements 120 are to be displayed. An advertiser 118 can prepare targeted advertisement parameters 116 in their requests to the Ad engine 114, wherein the advertiser 118 may want their advertisements 118 to be served to the one or more devices 122 in use by the users.

An Ad engine 114 may receive targeted advertisement parameters 116 for advertisements to determine which one or more users 101 are to be displayed this advertisement. An Ad engine 114 may then serve these advertisements to matching users 101 based on the targeted advertisement parameters 116 of the advertisements. In one embodiment, targeted advertisement parameters 116 may be received by the Ad engine 114, whereby the DME 112 is requested to identify a user 101, or users, that match the criteria of the requesting advertiser 118. Targeted advertisement parameters 116 may be received with the requests including data filtered by a user's demographics, biographic data, interests, specific keywords, etc.

One embodiment comprises an e-System 100 wherein an advertiser 118 is able to fit its advertisements 120 in the proper media format, or formats, in order to have these advertisements 120 served to one or more users, with their different devices, that have logged in the e-System 100. The advertiser 118 may use the e-System 100 to possibly keep track of or to attempt to know which device 106 the user 102 is using at a certain time of the day, as well as in a certain location 108. The advertiser 118, upon preparing their advertisements 120, may not know the kind of message or format they are required to prepare or need to fit about their advertisements 120, particularly at these times and locations 108.

The Ad engine 114 may request from the DME 112 data according to what an advertiser 118 desires to find out based on what on what requested from an advertiser through targeted advertisement parameters 116. For example, there may be a client advertiser that has criteria related to sending an advertisement to a certain age group, within a certain location, and with a certain advertisement that has to be delivered to a certain type of device. This is one working process of the Ad engine 114. In response to this example client and their certain criteria, the Ad engine 114 requests the DME 112 to give the users, or list of users, that match the criteria, and then with such a match in place, then pushes the client's advertisement according to the set criteria. The Ad engine 114, upon getting a request 116 with one or more data parameters from one or more advertisers, then retrieves the requested data from the DME 112. The Ad engine 114 receives from advertisers 118 that request to serve one or more advertisements 120 to the one or more devices 122 in use by the users based on parameters 116 set that may be satisfied from the data collected by the e-System 100 and the DME 112.

With the data shared from the DME 112 that may satisfy, or match, the request 116 with its parameters and conditions, the Ad engine 114 having this information may take the advertisements 120 provided by the advertisers 118 and fit the advertisement 120 in the proper media format in order to have these advertisements 120 served to the different devices 122 in use by the user. Stated another way, where the DME 112 has already the data to satisfy the advertiser's request 116, the Ad engine 114 may direct the e-System's servers to serve one or more advertisements 120 to the corresponding devices 122 of the logged user. So which advertisement 120 served to the respective devices 122 of the logged user, and in which media format, is based on the type and location of the devices 122.

The media format of the advertisement 120 may be conditioned on the type of device 122 in use by the user. The type of advertisements may include text or hypertext mark-up language (html) documentation, images, web pages, files embedded with audio, video, or images, high-definition versions of the images or video, or combinations herein. For example, if the user 102 is using a mobile device, the advertisement 120 may be served in text format. If the user 102 is logged into the e-System 100 with a laptop device, the media format that may best match the one or more advertisements 120 that are to be served may comprise text, images, video, or high-definition versions of the advertisements. The number of advertisements 120 that may be presented by the advertiser 118 may be limited by the number of devices 122 in use by the user.

The Ad engine 114, in addition to determining the preparation of the possibly different media format or formats of the advertisements 120 that may be served to the devices 122 in use by the user, additionally may determine whether to serve the same, different, or a combination of the same and different advertisements 120 to the devices 122 in use by the user. The advertiser 118 can specify which advertisements 120 are to be displayed on the devices 122 in use by the user at certain times and locations that match the targeted advertisement parameters 116 requested. Dependent on which, and how many of the user devices 122 are active, the advertiser 118 may display a variety of different advertisements 120, in a variety of different formats, such as text-only advertisements, image advertisements, audio advertisements, video advertisements, high-definition advertisements, or any combination.

One embodiment is of an advertiser 118 that is to serve one version of one advertisement 120 to all the active user devices 122. Alternatively, the advertiser 118 may serve to each active user device 122 a different advertisement 120. Another alternative is to serve to the more than one active user devices 122 a combination of the same and different advertisements. All these advertisements 120 that can be sent may include a variety of different media formats, including use of graphics, text, images, audio, video, and combinations of these. Where applicable given the allowance of the active user devices 122, the display can include high-definition imagery and video.

Another embodiment is of an advertiser 118 that is to serve one version of one advertisement 120 to all the active user devices 122. Alternatively, the advertiser 118 may serve to each active user device 122 a different advertisement 120. Another alternative is to serve to the more than one active user devices 122 a combination of the same and different advertisements. All these advertisements 120 that can be sent may include a variety of different media formats, including use of graphics, text, images, audio, video, and combinations of these. Where applicable given the allowance of the active user devices 122, the display can include high-definition imagery and video.

Where the data shared between the Ad engine 114 and the DME 112 does not satisfy the targeted advertisement parameters 116 in the requests from the advertisers 118, the Ad engine 114 may inform the advertiser that the RTCI 110 did not have data to match the targeted advertisement parameters 116 at the time or location requested. The Ad engine 114 may have the allowance to actively instruct the DME 112 to collect the requested data. With the data collected then collected by the DME 112 that satisfies the targeted advertisement parameters 116 in the requests from the advertisers 118, the Ad engine 114 may direct the e-System's servers to serve one or more advertisements 120 to the corresponding devices 122 of the logged user. So which advertisement 120 served to the respective devices 122 of the logged user, and in which media format, is based on the type and location of the devices 122.

FIG. 2 illustrates a social e-commerce networking process 200 showing an embodiment whereby an advertiser may serve one or more advertisements, with different messages or different media formats, to one or more devices of logged users within different filtered targeted interest groups based on group identification of a user, per context to location or to time, or per context to location and to time. The description of the process 200 includes reference to software functionality and one or more hardware components of the social e-commerce networking system noted in other parts of the writing and also by figures referenced. The process 200 may be operated utilizing or incorporating other steps and various other software functionality and one or more other hardware components.

FIG. 2. is a flowchart showing an illustrative overview process of social e-commerce networking system 200 functions related to one or more computer or mobile devices of a user, and targeted online and mobile social network advertising to implement in the environment of FIG. 1. The process 200 includes four steps: an initial step 202 to have users engage the social e-commerce networking system and select a targeted interest group; a second step where the DME 204 is collecting continuously contextual information data, per a device type, and context to location and context to time (204a), the DME 204 is grouping the collected data into different filtered targeted interest groups based on a group identification (204b), and the DME 204 is pushing out the data based on any request of that data (204c); a third step 206 where the Ad engine determines which advertisement, and how many, are displayed on a number of devices; and a fourth step 208 where changes in user device(s) and location(s), if any, determine whether there is further data collected through the DME 204 or the existing advertisements are further displayed on the existing device(s). The purpose of the DME 204 includes the continuous collection of the real time contextual information, with data collected against certain parameters provided by one or more sources, but typically an advertiser, with the data organized intone or more targeted interest groups, filtered by group identification, resulting in the data then being pushed out to those making the request related to the data, based on the targeted parameters used in that request.

FIG. 3 contains a block diagram of a social e-commerce networking system (e-System) 300, and that schematically illustrates a DME 306 in accordance with an embodiment of the present invention. In one embodiment, an e-System 300 comprises one or more servers, referred to herein for ease of reference as server 302, which incorporates target interest groups 304, a data mining engine (DME) 306, and an Ad engine 308. The e-System 300 may interact, connect, or communicate with the one or more mobile or computing devices 310 of a logged user via the internet or a network 312. An advertiser 314 may transfer their advertisements with their one or more messages or one or more media formats of preference to the e-System 300. Both the DME 304 and Ad engine 306 may be construed as in the e-System 300 and executed on the servers 302, which may be located in one or more locations, in one or more stages of integration or coordination, or include one or more server functions.

In other embodiments, the e-System 300 may include more or less, even different, modularity incorporating other applications. The types of devices 310 may include, but are not limited to, personal digital assistants, tablets, smart phones, laptop computing systems, net books, desktop computers, and other devices that integrate computing and data communication functionality. The internet or network 312 may comprise all types of networks, whether wired or wireless, and includes local area networks, wide area networks, virtual private networks, personal area networks, or combinations of these noted. The networks 312 may use linking technologies, including but not limited to 3G, 4G, 802.11, code division multiple access (CDMA), digital subscriber line (DSL), Ethernet, and worldwide interoperability for microwave access (WiMAX). The networks 312 may use protocols, such as file transfer protocol (FTP), hypertext transport protocol (HTTP), transmission control protocol/Internet protocol (TCP/IP), and the simple mail transfer protocol (SMTP).

The DME 306 may comprise one or more modules to perform different functionality related to continuous RTCI collection, grouping, and pushing of the social media data. In one embodiment, the DME 306 may comprise one or more embedded computer processors 316, or one or more general purpose processors, with software embedded or programmed to allow hardware complete all needed functionality of all modules incorporated within the DME 306 noted herein. A processor 316 may collect, retrieve, or assemble all data and data items, including functionality to extract, correlate, store, and categorize the data and its one or more user identifiers. A process in the embodiment may include output of a database with the interest identities, or data with common identities, such as target interest groups.

The data may be presented in a non data-centric manner, or a target-centric manner, where there is specific target user data, with data identified on focused context. Alternatively, data may be presented in a data-centric manner where such a database output is comprised of data about one user with a set of identifiers. Data specific to target interests may be grouped as one database, with extraction of the data possible with other one or more identifiers.

In one embodiment, a processor 316 may store collected or retrieved data items, and assembled data in storage 318. Data collected or extracted may be stored in storage 318 using various types of data structures, including hierarchical data structures, relational table structures, or other data structures that may require implementation using Structured Query Language. Storage 318 may comprise any storage device type, internal or remote, including disks, solid-state memory devices, or any device capable to hold information in data structures. Alternative embodiments may have a processor 316 collecting or extracting data which includes profile data of a user, subsequently including this data in storage 318 as part of a users' gathered data.

In one embodiment, the DME 306 includes a data categorization module 320, such its functional purpose is to categorize, or organize, index, or sort, the continuously collected RTCI by a variety of identifiers, including an interest connected with a target interest group 106 chosen by a user 101. In one embodiment, the DME 306, with its categorization module 320, may also categorize, index, or sort RTCI of a user by their profile, including demographics, usage patterns, keywords, or other criteria.

In one embodiment, the DME 306 includes an advertiser parameter response module 322 to provide data in response to a contextual content request for data from an advertiser 314, via the Ad engine 324. An advertiser parameter response module 322 may have functionality to address or analyze contextual content criteria of a targeted advertisement request from an advertiser 314, whereby an algorithm is used to search and target data to select matching data.

In one embodiment an algorithm may use various criteria to search data, such as historical collected data, user demographics, or real time contextual data, to determine what may be the best, or closest, match to respond to the request from an advertiser 314, whereby the Ad engine 324 may then provide a best advertisement to the one or more devices of a user of the e-System 300. An advertiser parameter response module 322 receives the targeted advertisement parameters identified in a request from an advertiser 314 to provide a best matching advertisement embodied in the ad object 104 to the users associated with the targeted user profile objects 116. The advertisement may be provided to users of the e-System 300 with an advertisement in the most appropriate media format channeled to the one or more active devices that satisfy the criteria of the advertiser's request.

An Ad engine 324 is configured to be connected with the servers 302 associated or connected together in the e-System 300. The Ad engine 324 is also bilaterally connected with the DME 306. An Ad engine 324 does not process the data, but has functionality that includes identifying a user based on the devices 310 in use by the user upon login to the e-System 300. An advertiser 314 may transfer their advertisements with their one or more messages, or one or more media formats of preference, to the e-System 300, which may be held in Storage 318, which may be connected directly internally or remotely. An advertiser 314 through requests, including targeted advertisement parameters, can indicate how and when these advertisements are to be served from the e-System 300, via the internet or network 312, to the devices 310 in use by the user upon login to the e-System 300. An Ad engine 324 may then prepare in different media formats the one or more advertisements of the advertiser 314 that are to be served by the e-System 300, via the internet or network 312, to the devices 310 in use by the user upon login to the e-System 300.

The details of the social e-commerce networking systems and methods described herein are only exemplary, with the embodiments, or examples, not to be limiting, such that variations can exist.

1-24. (canceled)

25. A social e-commerce networking system, comprising:
a plurality of a logged user's devices connected to one or more servers;
at least two active devices of a different type, each of the active devices being one of the plurality of the logged user's devices that the logged user is currently using;
a group identification associating the logged user with at least one of a plurality of targeted interest groups;
a data mining engine incorporated in at least one of the servers;
wherein the data mining engine is configured to:
collect continuous real time contextual data related to the logged user from more than one of the plurality of the logged user's devices,
generate filtered data by filtering the real time contextual data, and
output the filtered data based on a request for the filtered data; and
an advertising engine connected to at least one of the servers and the data mining engine;
wherein the advertising engine is configured to:
request filtered data from the data mining engine,
select a product or service to advertise to the logged user based on the filtered data, determine at least two similar type of advertisements, each to serve to one of the active devices, from a group of advertisements related to the selected product or service, based on the active device type, and
direct at least one of the plurality of servers to serve each of advertisements to their corresponding active device.

26. The system of claim 25, wherein the advertising engine determines the product or service to advertise based on at least one of location, time, and the at least one of the plurality of targeted interest groups associated to the logged user by the group identification.

27. The system of claim 25, wherein an advertiser submits the group of advertisements to the advertising engine, wherein the advertising engine is further configured to direct the at least one of the plurality of servers to serve a plurality of advertisements, wherein the advertisements having at least two different messages and at least two different media formats, and wherein the advertisements are served to a plurality of devices of a plurality of logged users within different targeted interest groups.

28. The system of claim 25, wherein the logged user has selected the at least one of a plurality of targeted interest groups.

29. The system of claim 25, wherein the data mining engine is further configured to generate the filtered data by filtering the real time contextual data according to the at least one targeted interest groups.

30. A social e-commerce networking system, comprising:
a plurality of user devices connected to one or more servers;
a group identification associating a logged user into the social e-commerce networking system with each of the targeted interest groups selected by the logged user;
a data mining engine incorporated with at least one of the servers and at least one of the targeted interest groups, configured to collect about each logged user continuous real time contextual data, to filter by each of the targeted interest groups selected by the logged user the collected continuous real time contextual data into different groups, identified by a different group identification, and to push out the data based on any request of that data; and
an advertising engine connected to at least one of the servers and the data mining engine, configured to share data with the data mining engine, or to request data from the data mining engine, and then prepare to serve a plurality of advertisements in a plurality of media formats based on device type;
wherein the advertising engine, upon getting a request with a plurality of data parameters from a plurality of advertisers, retrieves the requested data from the data mining engine, followed by the advertising engine directing the servers to serve a plurality of advertisements to the corresponding a plurality of devices of the logged user, per device type, context to location, context to time, and in media formats based on device type;
wherein the advertising engine determines at least two similar type of advertisements, each to serve to one of the active devices, from a group of advertisements related to the selected product or service, based on the active device type; and
wherein an advertiser may serve a plurality of advertisements, with at least one different message and at least one different media format, to a plurality of devices of logged users within different filtered targeted interest groups based on group identification of a user, per context to location or to time, or per context to location and to time.

31. The social e-commerce networking system of claim 30, wherein the advertising engine may serve a combination of a plurality of similar advertisements with a plurality of different advertisements to a plurality of mobile or computing devices of logged users.

32. The social e-commerce networking system of claim 30, wherein at least one of the formats that may be used by a plurality of advertisements that are served to a plurality of mobile or computing devices of logged users may include text.

33. The social e-commerce networking system of claim 30, wherein at least one of the formats that may be used by a plurality of advertisements that are served to a plurality of mobile or computing devices of logged users may include a plurality of images.

34. The social e-commerce networking system of claim 30, wherein at least one of the formats that may be used by a plurality of advertisements that are served to a plurality of mobile or computing devices of logged users may include a plurality of video.

35. The social e-commerce networking system of claim 30, wherein at least one of the formats that may be used by a plurality of advertisements that are served to a plurality of mobile or computing devices of logged users may include a plurality of high definition media.

36. The social e-commerce networking system of claim 30, wherein the context of at least one of the continuous real time contextual information data collected includes geographic location data.

37. The social e-commerce networking system of claim 30, wherein the context of at least one of the continuous real time contextual information data collected includes time.

38. The social e-commerce networking system of claim 30, wherein the context of at least one of the continuous real time contextual information data collected includes a plurality of devices in use by a user upon login to the social e-commerce networking system.
